(19) United States
(12) Patent Application Publication
(10) Pub. No.: US 2007/0177085 A1
(43) Pub. Date: Aug. 2, 2007

(54) LIQUID CRYSTAL DISPLAY DEVICE

(76) Inventors: Kazuhiro Nishiyama, Kanazawa-shi (JP); Mitsutaka Okita, Hakusan-shi (JP); Daiichi Suzuki, Sendai-shi (JP); Shigesumi Araki, Ishikawa-gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/627,073

(22) Filed: Jan. 25, 2007

(30) Foreign Application Priority Data
Jan. 31, 2006 (JP) 2006-023778
Nov. 2, 2006 (JP) 2006-298900

(51) Int. Cl. G02F 1/1335

(52) U.S. Cl. 349/117

(57) ABSTRACT

A liquid crystal display device includes a plurality of liquid crystal pixels PX equipped with an OCB liquid crystal layer between a pair of substrates, color filters CF including red, green, and blue color layers allocated so as to overlap on the plurality of liquid crystal pixels, and a polarizing plate PL arranged at least at a viewing side in opposite to the liquid crystal pixels, wherein the blue color layer has a contrast that is greater than that of the green color layer.

### CROSS-REFERENCE TO RELATED APPLICATIONS

This application is based upon and claims the benefit of priority from prior Japanese Patent Applications No. 2006-023778, filed Jan. 31, 2006; and No. 2006-298900, filed Nov. 2, 2006, the entire contents of both of which are incorporated herein by reference.

### BACKGROUND OF THE INVENTION

1. Field of the Invention

The present invention relates to a liquid crystal display device in an optically compensated bend (OCB) mode, and particularly to a liquid crystal display device capable of reducing coloring at the time of a black display.

2. Description of the Related Art

A liquid crystal display device for displaying an image is widely utilized in a computer, a car navigation system or television receiver equipment. In recent years, as a liquid crystal display device capable of improving a viewing angle and a response speed, an OCB type liquid crystal display device has been attracting attention.

The OCB type liquid crystal display device is featured in that a liquid crystal layer having liquid crystal molecules which enable bend arrangement is sandwiched between a pair of substrates. This OCB type liquid crystal display apparatus has an advantage that a response speed is improved by one digit as compared with a TN type liquid crystal display device, and further, a viewing angle is wide because an influence of birefringence of light passing through a liquid crystal layer can be optically self-compensated based on an arrangement state of liquid crystal molecules.

In the meantime, in the liquid crystal display device, at the time of black display that is a minimum gradation, for example, blue coloring is occasionally recognized. This phenomenon occurs in common with the liquid crystal display device. A technique of eliminating coloring at the time of this black display by adjusting a contrast of a color filter (CF) is disclosed. Specifically, in the case of enhancing the contrast, a pigment with a high coloring force and small particle size is contained in the color filter at a low concentration (Jpn. Pat. Appln. KOKAI Publication No. 2005-173078).

### BRIEF SUMMARY OF THE INVENTION

According to a first aspect of the present invention, there is provided a liquid crystal display device, comprising: a plurality of liquid crystal pixels equipped with an OCB liquid crystal layer between a pair of substrates, color filters including red, green, and blue color layers allocated so as to overlap on the plurality of liquid crystal pixels, and a polarizing plate arranged at least at a viewing side in opposite to the liquid crystal pixels, wherein the blue color layer has a contrast that is greater than that of the green color layer.

According to a second aspect of the present invention, there is provided a liquid crystal display device, comprising: a plurality of liquid crystal pixels equipped with an OCB liquid crystal layer between a pair of substrates; color filters including red, green, and blue color layers allocated so as to overlap on the plurality of liquid crystal pixels; and a polarizing plate arranged at least at a viewing side in opposite to the liquid crystal pixels, wherein at least one of the color filters includes a light transmission region that transmits light from the liquid crystal pixels at a transmittance that is higher than that of a periphery.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing a circuit configuration of a liquid crystal display device according to a first embodiment of the present invention;

FIG. 2 is a view schematically showing a sectional structure of a liquid crystal display panel shown in FIG. 1;

FIG. 3 is a view showing a relationship between red (R), green (G), and blue (B) color layers and pixels of a color filter shown in FIG. 2;

FIG. 4A is a view illustrating a method for measuring a contrast of the color filter shown in FIG. 2;

FIG. 4B is a view illustrating a method for measuring a contrast of the color filter shown in FIG. 2;

FIG. 5 is a view showing a contrast characteristic of a conventional general color filter;

FIG. 6 is a view showing a contrast characteristic of the color filter shown in FIG. 2;

FIG. 7 is a view showing a simplified sectional structure of a liquid crystal display panel provided in a liquid crystal display device according to a second embodiment of the present invention;

FIG. 8A is a view showing a layout example of an optical leakage region provided in a color filter shown in FIG. 7;

FIG. 8B is a view showing a layout example of an optical leakage region provided in the color filter shown in FIG. 7;

FIG. 9 is a view illustrating an advantageous effect obtained in each of the embodiments;

FIG. 10 is a sectional view schematically showing a configuration of an OCB type liquid crystal display device according to an embodiment of the present invention;

FIG. 11 is a view schematically showing a configuration of an optical compensation element applied to the OCB type liquid crystal display device;

FIG. 12 is a view showing a relationship between an optical axis direction and a liquid crystal alignment direction of each of optical members that configure the optical compensation element;

FIG. 13 is a view for illustrating retardation that occurs in a liquid crystal layer when a screen has been observed in an oblique direction;

FIG. 14 is a view for illustrating optical compensation of the retardation that occurs in the liquid crystal layer;

FIG. 15 is a view showing an example of a wavelength dispersion characteristic of a degree of retardation Δn·d caused by each of the optical members in the liquid crystal display device having the configuration shown in FIG. 11;

FIG. 16 is a view schematically showing a configuration of an OCB type liquid crystal display device according to a fourth embodiment;

FIG. 17 is a view showing an example of a wavelength dispersion characteristic of a degree of retardation Δn·d caused by each of the optical members in the liquid crystal display device having the configuration shown in FIG. 16;

FIG. 18 is a view schematically showing a configuration of an OCB type liquid crystal display device according to a fifth embodiment;

FIG. 19 is a view schematically showing a configuration of an OCB type liquid crystal display device according to a sixth embodiment;

FIG. 20 is a view schematically showing a configuration of an OCB type liquid crystal display device according to a seventh embodiment;

FIG. 21 is a view showing an example of a wavelength dispersion characteristic of a degree of retardation Δn·d caused by each of the optical members in the liquid crystal display device having the configuration shown in FIG. 20;

FIG. 22 is a block diagram depicting a configuration of a liquid crystal display device according to the present embodiment;

FIG. 23 is a graph for illustrating a signal voltage conversion table provided in a display voltage applicator of the liquid crystal display device according to the present embodiment;

FIG. 24 is a graph illustrating luminance voltage characteristic data stored in a storage element provided in the liquid crystal display device according to the present embodiment; and

FIG. 25 is a view schematically showing a configuration of a transmission type liquid crystal display device.

### DETAILED DESCRIPTION OF THE INVENTION

Now, a liquid crystal display device according to a first embodiment of the present invention will be described with reference to the accompanying drawings.

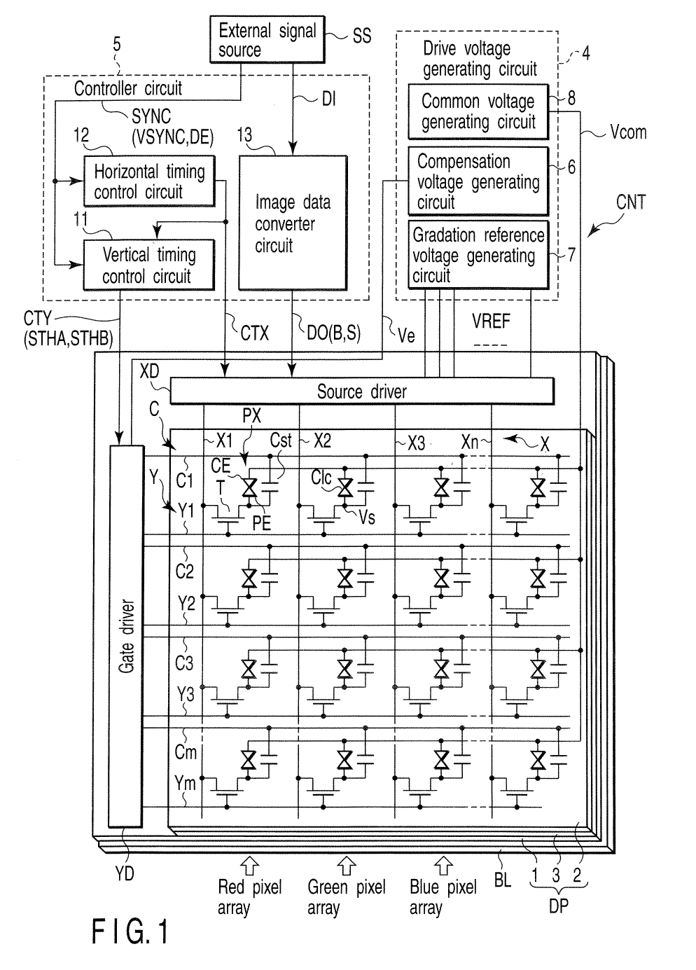

FIG. 1 is a view schematically showing a circuit configuration of the liquid crystal display device according to the first embodiment of the present invention.

The liquid crystal display device is equipped with a liquid crystal display panel DP, a backlight BL, and a display control circuit CNT. The backlight BL illuminates the display panel DP. The display control circuit CNT controls the display panel DP and the backlight BL.

The liquid crystal display panel DP is structured to sandwich a liquid crystal layer 3 between an array substrate 1 and an opposite substrate 2 that are a pair of electrode substrates. The liquid crystal layer 3 is transferred from spray alignment state to bend alignment state in advance for the sake of an operation of displaying normally white, for example. Then, inverse transfer from bend alignment state to spray alignment state is inhibited by means of a voltage periodically applied.

The display control circuit CNT controls a transmission rate of the liquid crystal display panel DP by applying a liquid crystal drive voltage from the array substrate 1 and the opposite substrate 2 to the liquid crystal layer 3. In addition, the display control circuit CNT transfers liquid crystal alignment state from spray alignment state to bend alignment state by applying a comparatively large electric field to a liquid crystal in accordance with initialization processing at the time of supplying power.

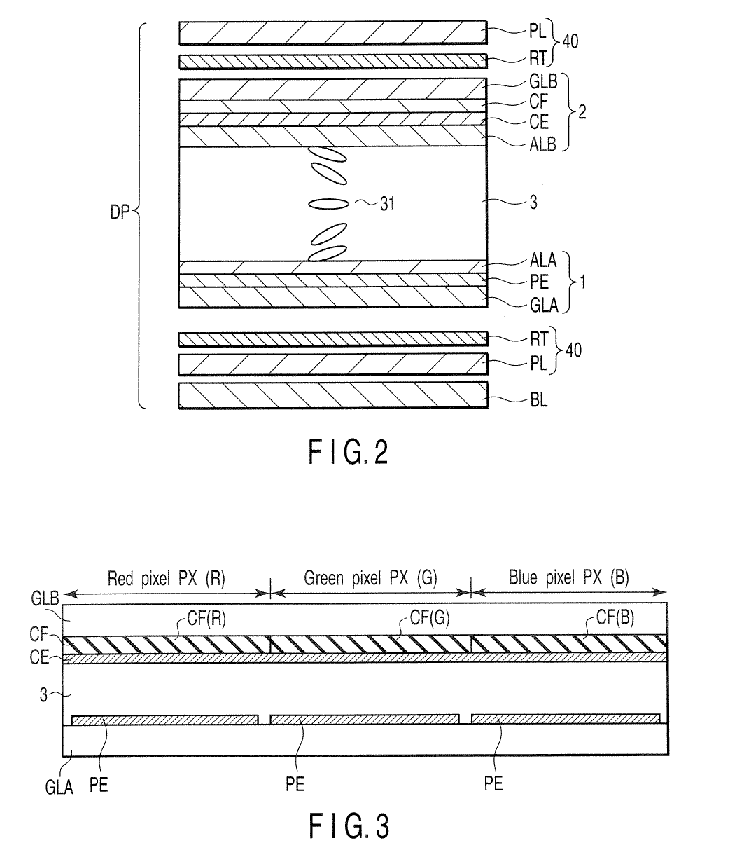

FIG. 2 is a view schematically showing a sectional structure of a liquid crystal display panel shown in FIG. 1.

The array substrate 1 includes a transparent insulation substrate GLA, a plurality of pixel substrates PE, and an alignment film ALA. The transparent insulation substrate GLA is made of a glass substrate or the like. A plurality of pixel electrodes PE is formed on this transparent insulation substrate GLA. The alignment films ALA are formed on these pixel electrodes PE.

The opposite substrate 2 includes a transparent insulation substrate GLB, a color filter layer CF, an opposite electrode CE, and an alignment film ALB.

The transparent insulation substrate GLB is made of a glass substrate or the like. The color filter layer CF is formed on this transparent insulation substrate GLB. The opposite electrode CE is formed on this color filter layer CF. The alignment film ALB is formed on this opposite electrode CE.

The liquid crystal layer 3 is obtained by charging a liquid crystal material in a gap between the opposite substrate 2 and the array substrate 1. In FIG. 2, liquid crystal molecules 31 are established in a bend aligned state.

The liquid crystal display panel DP is equipped with a pair of optical compensation elements 40 and a light source backlight BL allocated outside of the array substrate 1 and the opposite substrate 2. In addition, the optical compensation elements 40 have polarizing plates PL allocated outside of a phase difference plate RT and a phase difference plate RT.

The alignment film ALA at the side of the array substrate 1 and the alignment film ALB at the side of the opposite substrate 2 are processed to be rubbed parallel to each other. In this manner, a pre-tilt angle of liquid crystal molecules is set to about 10°.

On the array substrate 1, a plurality of pixel electrodes PE are allocated in a substantial matrix shape on the transparent insulation substrate GLA. In addition, a plurality of gate lines Y (Y1 to Ym) are allocated along a line of the plurality of pixel electrodes PE, and a plurality of source lines X (X1 to Xn) are allocated along a column of the plurality of pixel electrodes PE.

In the vicinity of crossing positions between these gate lines Y and source lines X, a thin film transistor T is allocated as a pixel switching element. A gate of each thin film transistor T is connected to the gate line Y, and a source-drain path is formed to be connected between the source line X and the pixel electrode PE. Each thin film transistor T is electrically conductive when the transistor has been driven via the corresponding gate line Y, and an electric potential of the corresponding source line X is applied to the pixel electrode PE.

Each pixel electrode PE and an opposite electrode CE each are made of a transparent electrode material such as ITO, for example, each of which is covered with the alignment films ALA and ALB. Each one of liquid crystal pixels PX is configured of each pixel electrode PE, opposite electrode CE, and the liquid crystal layer 3 between each pixel electrode PE and opposite electrode CE. Then, when a liquid crystal drive voltage is applied between the pixel electrode PE and the opposite electrode CE, a liquid crystal molecular alignment configuring a liquid crystal pixel PS is controlled by means of a generated electric field.

A plurality of liquid crystal pixels PX has a liquid crystal capacity Clc composed of each pixel electrode PE and opposite electrode CE. A plurality of storage capacitor lines C1 to Cm each configure an storage capacitor Cst by capacity-coupling with the pixel electrode PE of the liquid crystal pixels PX in the corresponding line.

The display control circuit CNT is equipped with a gate driver YD, a source driver XD, a drive voltage generating circuit 4, and a controller circuit 5.

The gate driver YD sequentially drives a plurality of gate lines Y1 to Ym so as to make a plurality of thin film transistors T electrically conductive on a line by line basis. The source driver XD outputs a pixel voltage Vs to each one of the plurality of source lines X1 to Xn in a period in which the thin film transistors T in each line are made electrically conductive by driving the corresponding gate line Y. The drive voltage generating circuit 4 generates a drive voltage of the display panel DP. The controller circuit 5 controls the gate driver YD and the source driver XD.

The drive voltage generating circuit 4 includes a compensation voltage generating circuit 6, a gradation reference voltage generating circuit 7, and a common voltage generating circuit 8.

The compensation voltage generating circuit 6 generates a compensation voltage Ve applied to an storage capacitor line C via the gate driver YD. The gradation reference voltage generating circuit 7 generates a predetermined number of gradation reference voltages V_{REF} used by the source driver XD. The common voltage generating circuit 8 generates a common voltage Vcom applied to the opposite electrode CE.

The controller circuit 5 includes a vertical timing controller circuit 11, a horizontal timing controller circuit 12, and an image data converter circuit 13.

The vertical timing controller circuit 11 generates a control signal CTY with respect to the gate driver YD based on a sync signal SYNC inputted from an external signal source SS. The horizontal timing controller circuit 12 generates a control CTX with respect to the source driver XD based on the sync signal SYNC inputted from the external signal source SS. The image data converter circuit 13 converts image data inputted from the external signal source SS to pixel data DO relevant to a plurality of pixels PX. In addition, data conversion for back insertion drive is executed.

Image data is made of a plurality of pixel data DO relevant to the plurality of pixels PX, and then, is updated every one frame period (vertical scanning period V). The control signal CTY is supplied to the gate driver YD, and is used to cause the gate driver YD to make an operation of sequentially driving the plurality of gate lines Y, as described above. The control signal CTX is supplied to the source driver XD together with the pixel data DO obtained as a conversion result from the image data converter circuit 13. The control signal CTX is used to cause the source driver XD to make an operation of assigning to the plurality of source lines X the pixel data DO that corresponds to the liquid crystal pixel PX on line by line basis as a conventions result of the image data converter circuit 13 and specifying output polarity.

The gate driver YD and the source driver XD are configured using a shift register circuit, for example, in order to select the plurality of gate lines Y and the plurality of source lines X, respectively.

The control signal CTX includes a start signal, a clock signal, a load signal, a polarity signal and the like.

The start signal controls a timing of starting acquisition of pixel data for one line. The clock signal shifts this start signal in the shift register circuit. The load signal controls a parallel output timing of the pixel data DO for one line acquired, respectively with respect to the source lines X1 to Xn selected on a one by one element basis by means of the shift register circuit in response to a hold position of the start signal. The polarity signal controls signal polarity of the pixel voltage Vs that corresponds to pixel data.

The gate driver YD sequentially selects the plurality of gate lines Y1 to Ym for gradation image display and for black insertion (non-gradation image display) in a one-frame period under the control of the control signal CTY. Then, the gate driver YD supplies an ON voltage serving as a drive signal to a selected gate line Y, and then, makes the thin film transistors T of each line electrically conductive for only one horizontal scanning period H.

The pixel voltage Vs is provided as a voltage applied to the pixel electrode PE while the common voltage Vcom of the opposite electrode CE is defined as a reference. The pixel voltage Vs is polarity-inversed in response to the common voltage Vcom on a line by line basis or on a frame by frame basis so as to carry out line inversion driving and frame inversion driving (1H1V inversion driving), for example.

In addition, the compensation voltage Ve is applied via the gate driver YD to storage capacitor lines C that correspond to these thin film transistors T when the thin film transistors T for one line become electrically non-conductive. The pixel voltage Vs compensates for a fluctuation of the pixel voltage Vs that is generated on the pixels PX for one line by means of a parasitic capacity of these thin film transistors T.

When the gate driver YD drives a gate line Y1, for example, by an ON voltage, and then, makes all of the thin film transistors T connected to this gate line Y1 electrically conductive, the pixel voltages Vs on the source lines X1 to Xn are supplied to one end of each of the corresponding pixel electrode PE and storage capacitor Cst via each of these thin film transistors T.

In addition, the gate driver YD outputs the compensation voltage Ve from the compensation voltage generating circuit 6 to an storage capacitor line C1 that corresponds to this gate line Y1. Then, an OFF voltage that makes electrically nonconductive these thin film transistors T is outputted to the gate line Y1 immediately after all of the thin film transistors T connected to the gate line Y1 have been made electrically conductive for only one horizontal scanning period.

The compensation voltage Ve substantially cancels fluctuation of the pixel voltage Vs due to an effect of the parasitic capacity thereof, i.e., a penetration voltage ΔVp when these thin film transistors T have been electrically nonconductive.

FIG. 3 is a view showing a relationship between red (R), green (G), and blue (B) color layers and pixels of the color filter shown in FIG. 2.

FIG. 3 depicts the alignment films ALA and ALB, the phase difference plate RT, the polarizing plate PL and the like shown in FIG. 2 in a partially omitted manner. The color filter layer CF includes a red color layer CF (R), a green color layer CF (G), and a blue color layer CF (B) formed in a stripe shape, these layered being repeatedly arranged in the line direction, each of which is opposed to a column of a plurality of pixel electrodes PE.

Here, the red color layer CF (R) is opposed to the pixel electrodes PE in first, fourth, seventh, and subsequent columns, and the liquid crystal pixels PX corresponding to these pixel electrodes PE are set in red pixels PX (R). The green color layer CF (G) is opposed to the pixel electrodes PE in second, fifth, eighth, and subsequent columns, and the liquid crystal pixels PX corresponding to these pixel electrodes PE are set in green pixels PX (G). The blue color layer CF (B) is opposed to the pixel electrodes PE in third, sixth, ninth, and subsequent columns, and the liquid crystal pixels PX corresponding to these pixel electrodes PE are set in blue pixels PX (B).

Now, a description will be given with respect to causes for which coloring occurs at the time of black display when a screen is observed in an oblique direction in an OCB type liquid crystal display device.

In the case where black is displayed using the OCB type liquid crystal display device, for example, it is deemed to interrupt light and display black at the time of applying a high voltage, and to transmit light and display white at the time of applying a low voltage. Therefore, at the time of displaying black, a majority of liquid crystal molecules are arranged along an electric field direction by applying a high voltage. That is, the majority of liquid crystal molecules are arranged in normal direction of a substrate. However, the liquid crystal molecules in the vicinity of the substrate are not arranged in the normal direction due to interaction with an alignment film, and light is affected by a phase difference in a predetermined direction.

As a result, in particular, at the time of displaying black, coloring is significantly recognized when a screen has been observed in an oblique direction with respect to a direction orthogonal to a rubbing direction of alignment films (liquid crystal alignment direction).

Subsequently, a description will be given with respect to causes for which blue coloring is provided at the time of displaying black by an OCB liquid crystal display device.

### (1) Characteristics of Polarizing Plate

In a black display, in particular, light is interrupted using a polarizing plate and a liquid crystal, thereby expressing black. The polarizing plate is allocated in a cross-Nicol manner so as to sandwich a liquid crystal layer and so as to prevent the leakage of light. However, essentially, as a characteristic of the polarizing plate, light is not completely interrupted in all wavelength regions, and, for example, part of blue light transmits the polarizing plate.

### (2) Scattering Characteristic of Pigment for Use in Color Filter

In the case where only the polarizing plate is allocated in a cross-Nicol manner, and then, light is made incident, substantial light emission is interrupted. However, when a color filter is inserted between these polarizing plates, light leakage occurs. This is believed to be because the polarizing characteristic is deformed since light is scattered due to the pigment used for the color filter, and due to this effect, the light having a certain wavelength passes through the polarizing plate.

This phenomenon occurs in any of a case in which a screen has been observed from the frontal side and a case in which a screen has been obliquely observed.

### (3) Light Wavelength Dispersion Characteristic

As described above, in an OCB liquid crystal, the liquid crystal molecules in the vicinity of a substrate are not arranged in normal direction due to interaction with an alignment film, and thus, light leakage occurs in the case where a screen has been obliquely observed. In the case of optically compensating for this light leakage, there is a need for considering the wavelength dispersion characteristic of the OCB liquid crystal.

That is, liquid crystal retardation differs depending on a light wavelength. Assuming that a center wavelength of red (R) is 617 nm, a center wavelength of green (G) is 550 nm, and a center wavelength of blue (B) is 430 nm, even if proper optical compensation has been carried out at the center wavelength of 550 nm of green (G), proper adjustment is not made with respect to red (R) and blue (B) having different wavelengths therefrom. Thus, the liquid crystal later thickness is differentiated among red (R), green (G), and blue (B), respectively, or alternatively, an applied voltage is controlled independently, whereby the coloring produced when a screen has been observed obliquely in a direction orthogonal to a liquid crystal alignment direction can be eliminated to a certain extent, requiring further improvement.

Due to the causes described in items 1 to 3 above, coloring in a black display occurs. At this time, a blue (B) color strongly appears in a black display in accordance with a scattering characteristic of a filter that an OCB liquid crystal has, a light wavelength distribution characteristic, and a polarizing plate light interruption characteristic.

Therefore, in the liquid crystal display device according to each of the embodiments of the present invention described below, there is provided a configuration considering the color filter scattering characteristic and the light wavelength dispersion characteristic.

### First Embodiment

Now, a description will be given with respect to a liquid crystal display device according to a first embodiment of the present invention. The first embodiment considers scattering properties of a color filter.

The components and composition of pigments are different among red (R), green (G), and blue (B), and thus, their scattering properties are also different among red (R), green (G), and blue (B), respectively. On the other hand, there is a relationship between scattering and a contrast, as described later.

The contrast used here is defined as a ratio between the transmittance obtained when two polarizing plates are overlapped on each other so that their polarizing axes become parallel and the transmittance obtained when they are overlapped on each other so that their polarizing axes become orthogonal to each other.

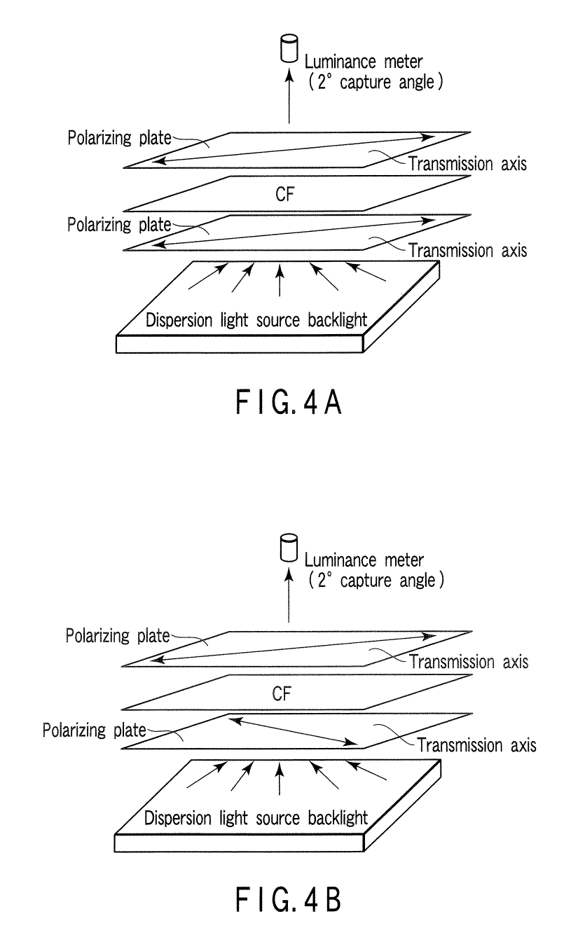

FIGS. 4A and 4B are views each illustrating a method for measuring a contrast of a color filter.

FIG. 4A represents a measuring method under a polarizing plate parallel Nicol. Two polarizing plates are laminated on each other so that their polarizing axes become parallel, and then, the overlapped polarizing plates are installed while a color filter (CF) is inserted therebetween. Then, using a scattering light source as a backlight, the transmitted light quantity is measured by means of a luminance meter having directivity of a capture angle of 2°, thereby obtaining a transmittance T1.

FIG. 4B represents a measuring method under a polarizing plate cross Nicol. The cross Nicol is different from the parallel Nicol in that two polarizing plates are overlapped on each other so that their polarizing axes are orthogonal to each other. The cross Nicol is similar to the parallel Nicol in other constituent elements and measuring method, and the measured transmittance is defined as T2.

Then, a contrast CR of a color filter is defined by formula (1).

CR=T1/T2 formula (1)

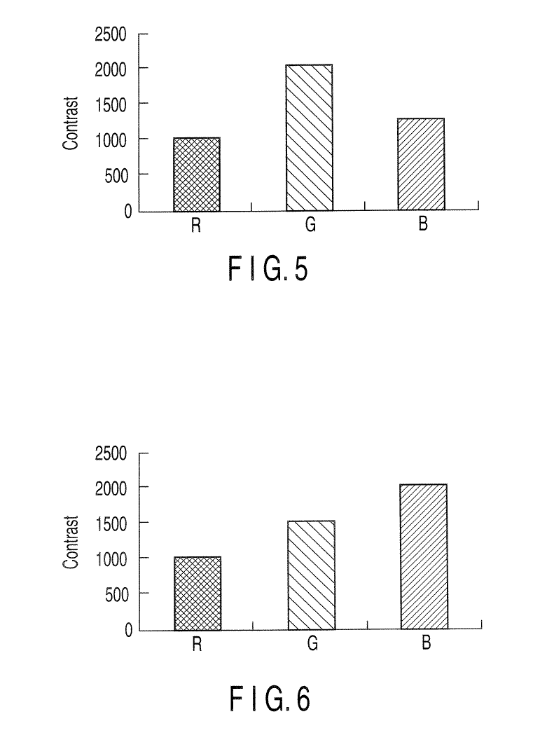

FIG. 5 is a view showing a contrast characteristic of a conventional general color filter.

The components of pigments are different among red (R), green (G), and blue (B). In general, green (G) greatly contributes to brightness, and thus, is configured so that the color filter of green (G) is unlikely to scatter light. Specifically, a process such as reducing particle size of the pigment or providing a dispersion process for eliminating coagulation in a pigment manufacturing process is applied.

According to FIG. 5, the contrast of green (G) is greater as compared with the contrasts of red (R) and blue (B). This is deemed to be because the color filter of green (G) is configured so that light scattering is reduced, thus reducing leakage of light due to scattering and reducing the transmittance T2. On the other hand, in the color filters of red (R) and blue (B), this is believed to be because light scattering occurs from a relationship between pigments and particle sizes, thus increasing leakage of light due to scattering and increasing the transmittance T2.

From this fact, it can be presumed that a large contrast of a color filter represents a small amount of scattering and a small contrast represents a large amount of scattering.

The inventors attempted to improve the contrast characteristic of a color layer of blue (B) based on this finding. Then, measurement was carried out using a variety of combinations of color filters, and then, a condition for reducing bluing at the time of black display was found out. The contrast enhancement was carried out by controlling the particle size and coagulation of pigments for use in the color filter, as described above.

FIG. 6 is a view showing an example of a contrast characteristic of a color filter capable of reducing bluing.

The specification of a measuring system used for this contrast measurement is as follows.

In measurement of the transmittance T1, there was used a sample obtained by overlapping two polarizing plates available from Luceo Co., Ltd. (product number: POLAX-38S) on each other so that their polarizing axes become parallel, and then, inserting a color filter (CF) of a predetermined film thickness coated on a glass having thickness of 1.1 mm therebetween. Then, for a backlight, there was used a cold cathode tube available from Harrison Toshiba Lighting Co., Ltd., obtained by sequentially allocating a scattering sheet (D121UY available from Tsujiden Co. Ltd.); a prism sheet (H) (BEF III 90/50T-7 available from Sumitomo 3M Co., Ltd); a prism sheet (V) (BEF III 90/50T-7 available from Sumitomo 3M Co., Ltd.); and a polarizing separation sheet (DBEF-D available from Sumitomo 3M Co., Ltd.). A light quantity having transmitted through the sample was measured by means of a luminance meter (SR-3A-L1) available from Topcon Techno House Co., Ltd., having directivity of a capture angle of 2°, and then, the transmittance T1 was obtained.

In addition, in measurement of the transmittance T2, there was used a sample obtained by overlapping two polarizing plates (product number: POLAX-38S) available from Luceo Co., Ltd on each other so that their polarizing axes become a cross Nicol, and then, inserting a color filter (CF) of a predetermined film thickness coated on a glass having thickness of 1.1 mm therebetween. For a backlight, in the same manner as that described above, a scattering light source was used. A light quantity having transmitted through the sample was measured by a luminance meter having directivity of a capture angle of 2°, and then, the transmittance T2 was obtained.

From T1 and T2 described above, a contrast CR of a color filter is calculated.

In FIG. 6, unlike the conventional contrast characteristic, the contrast of a color layer of blue (B) is higher than that of a color layer of green (G). The present embodiment is featured in that the contrast of the color layer of blue (B) is set to be higher than that of the color layer of green (G).

In measurement using the measuring system described above, it is desirable that, while a high contrast is obtained as a whole, the contrast of the color layer of blue (B) capable of reducing bluing be equal to or greater than 2000:1.

Further, the present embodiment is also featured in that the contrast of the color layer of blue (B)>the contrast of the color layer of green (G)>the contrast of the color layer of red (R) is set. The contrast of the color layer of green (G)>the contrast of the color layer of red (R) is set in order to improve a comprehensive characteristic relating to a color display.

A variety of methods can be used to change the contrast of the color filter. For example, a dying agent, an ink, a pigment, a color resist or the like for use in manufacture of a color filter may be changed, and a process for manufacturing the color filter or a method for manufacturing the color filter itself may be changed. Objects of such change are for controlling scattering or controlling a contrast.

### Second Embodiment

A liquid crystal display device according to a second embodiment is different from that of the first embodiment in the configuration of a color filter. Therefore, like constituent elements are designated by like reference numerals, and a detailed description thereof is omitted here.

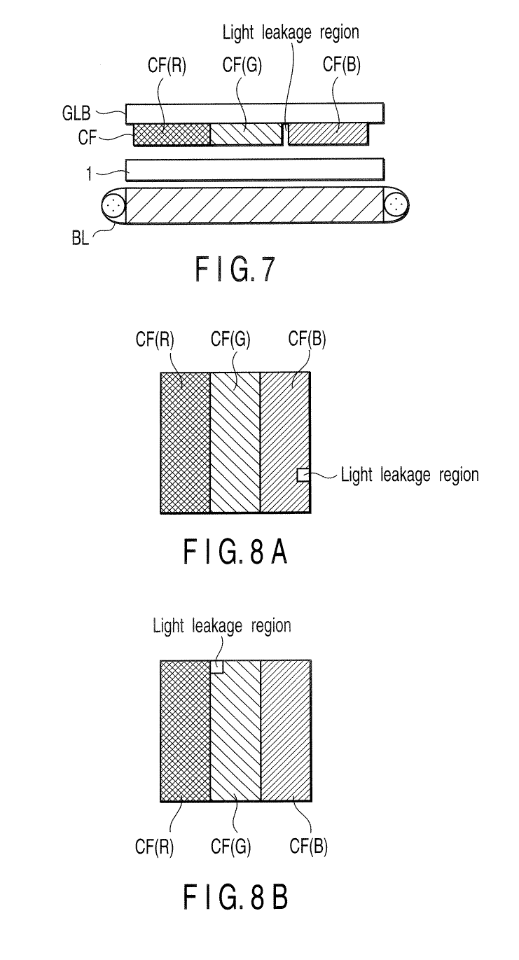

FIG. 7 is a view showing a simplified sectional structure of a liquid crystal display panel provided on the liquid crystal display device according to the second embodiment of the present invention.

FIG. 7 depicts an example while the alignment films ALA and ALB, the phase difference plate RT, the polarizing plate PL and the like shown in FIG. 2 are omitted. In a conventional liquid crystal display panel DP, backlight's light is exited to the outside after passing through any of the filters of red (R), green (G), and blue (B). In contrast, on the liquid crystal display panel DP of the present embodiment, there is provided a slight region in which no filter is present in a color filter layer CF (a region in which no transmission wavelength is controlled in a visible region). Therefore, among the whole light quantity of the backlight, a slight light quantity is exited to the outside without passing through any of the filters of red (R), green (G), and blue (B).

As a result, white light becomes slightly incident at the time of black display, whereby an image that has been blued conventionally is remarkably improved, and a black display with almost no coloring can be obtained.

However, when white light is incident, the contrast characteristic is degraded. Therefore, the inventors discussed this matter, and found out that, in the case where a region of this light leakage is greater than 1/15 of the whole aperture region of blue pixels (B), the contrast characteristic is degraded. That is, it was found that, in the case where the region of this light leakage is equal to or smaller than 1/15 of the whole aperture region, degradation of the contrast characteristic is retained in a permissible range. In addition, as long as this light leakage region has an area equal to or greater than 3 μm in square, a bluing reduction effect has been successfully attained.

FIGS. 8A and 8B are views each showing a layout example of a light leakage region provided in the color filter shown in FIG. 7.

As shown in FIGS. 8A and 8B, a light transmission region in which transmission occurs at a transmittance higher than that of the periphery (hereinafter, referred to as a light leakage region) may be provided in any of the color layers of red (R), green (G), and blue (B) in response to a color colored at the time of black display without being limited to a specific color filter. In addition, the light leakage region may be provided in an arbitrary region in the color filter without being limited to the vicinity of the boundary of the color filter. As long as this light leakage region has an area of 3 μm or more in square, a bluing reduction effect has been successfully attained.

Further, as shown in FIGS. 8A and 8B, there is no need for the light leakage region to be a region in which no color filter exists. The light leakage region may be a region in which a color filter is partially thin (an area in which control of a transmission wavelength in a visible region is smaller than that of any other wavelength). For example, the light leakage region may be provided as a region having a film thickness half that of the peripheral region.

Now, a description will be given with respect to a method for more significantly reducing coloring of an OCB type liquid crystal display device in consideration of a light wavelength dispersion characteristic. The color filter for use in each of the embodiments described hereinafter, are the color filter described in the foregoing first or second embodiment.

### Third Embodiment

Now, a description will be given with respect to a liquid crystal display device according to a third embodiment. The third embodiment considers a light wavelength dispersion characteristic. In the third embodiment, like constituent elements of the first embodiment are designated by like reference numerals.

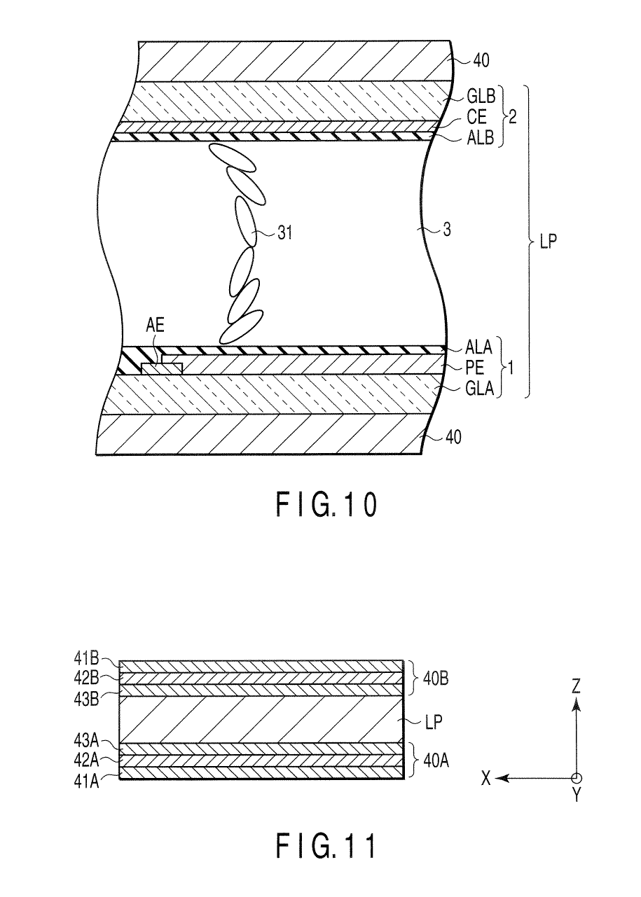

As shown in FIG. 10, the OCB type liquid crystal display device is equipped with a liquid crystal panel LP configured by sandwiching a liquid crystal layer 3 between a pair of substrates, i.e., between an array substrate 1 and an opposite substrate 2. This liquid crystal panel LP is of transmission type, for example, and is configured so that the backlight's light from a backlight unit, although not shown, allocated at the side of the array substrate 1, can be transmitted to the side of the opposite substrate 2.

The array substrate 1 is formed using an insulation substrate GLA such as a glass. This array substrate 1 is equipped with an active element AE, a pixel electrode PE, an alignment film ALA and the like on one main face of the insulation substrate GLA. The active element AE is composed of a thin-film transistor (TFT), a metal-insulator-metal (MIM) and the like. The pixel electrode PE is allocated on a pixel by pixel basis, and is electrically connected to the active element AE. This pixel electrode PE is formed of an electrically conductive member having light transmission property such as indium tin oxide (ITO) or the like. The alignment film ALA is allocated so as to cover the whole main face of the insulation substrate GLA.

The opposite substrate 2 is formed using an insulation substrate GLB such as a glass. This opposite substrate 2 is equipped with an opposite electrode CE, an alignment film ALB and the like on one main face of the insulation substrate GLB. The opposite electrode CE is formed of an electrically conductive member having light transmission property such as ITO, for example. The alignment film ALB is allocated so as to cover the whole main face of the insulation substrate GLB.

In the liquid crystal display device of a color display type, a liquid crystal panel LP has color pixels of a plurality of colors, red (R), green (G), and blue (B), for example. That is, the red pixel has a red color filter that transmits light having a red color wavelength; the green pixel has a green color filter that transmits light having a green color wavelength; and the blue pixel has a blue color filter that transmits light having a blue color wavelength. These color filters each are allocated on a main face of the array substrate 1 or the opposite substrate 2.

As these color filters, there are used the color filters described in the first or second embodiment.

The array substrate 1 and the opposite substrate 2 each having their configuration described above are adhered to each other via a spacer, although not shown, in a state in which a predetermined gap has been maintained. The liquid crystal layer 3 is sealed in a gap between the array substrate 1 and the opposite substrate 2. For a liquid crystal molecule 31 included in the liquid crystal layer 3, there can be selected a material having positive dielectric anisotropy and having optically positive uniaxial property.

Such an OCB type liquid crystal display device is equipped with an optical compensation element 40 for optically compensating for retardation of the liquid crystal layer 3 in a predetermined display state in which a voltage has been applied to the liquid crystal layer 3. This optical compensation element 40, for example, as shown in FIG. 11, is provided on each one of an outer face at the side of the array substrate 1 and on an outer face at the side of the opposite substrate 2 of the liquid crystal panel LP.

An optical compensation element 40A at the side of the array substrate 1 has a polarizing plate 41A and a plurality of phase difference plates 42A and 43A. Similarly, an optical compensation element 40B at the side of the opposite substrate 2 has a polarizing plate 41B and a plurality of phase difference plates 42B and 43B. The phase difference plates 42A and 42B function as phase difference plates having retardation (phase difference) in its thickness direction. In addition, the phase difference plates 43A and 43B function as phase difference plates having retardation (phase difference) in its frontal face direction, as described later.

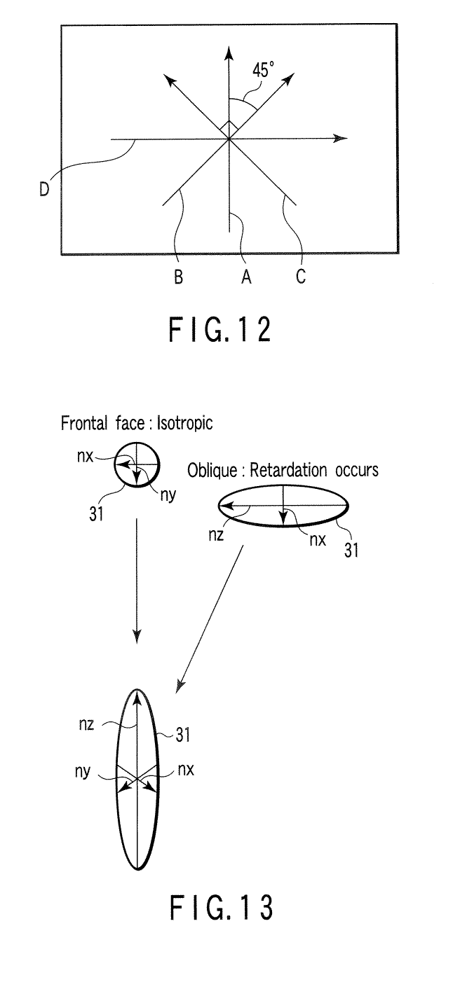

As shown in FIG. 12, the alignment films ALA and ALB are processed to be aligned parallel to each other. That is, these films are processed to be rubbed in the direction indicated by the arrow A shown in the figure. In this manner, a positive projection of an optical axis of the liquid crystal molecule 31 (liquid crystal alignment direction) becomes parallel to the direction indicated by the arrow A in the figure. In a state in which an image can be displayed, i.e., in a state in which a predetermined bias has been applied, the liquid crystal molecule 31 is aligned in a bend manner between the array substrate 1 and the opposite substrate 2 in a cross section of the liquid crystal layer 3 specified by the arrow A.

At this time, the polarizing plate 41A is allocated so that its transmission axis is oriented in the direction indicated by the arrow B shown in the figure. In addition, the polarizing plate 41B is allocated so that its transmission axis is oriented in the direction indicated by the arrow C shown in the figure. Namely, one transmission axis of each one of the polarizing plates 41A and 41B forms an angle of 45° with respect to the liquid crystal alignment direction A, and moreover, is orthogonal to the other transmission axis. In this manner, allocation in which the transmission axes of the polarizing plates are orthogonal to each other is referred to as a cross Nicol; light is not transmitted as long as a double refraction quantity (degree of retardation) of a certain object therebetween is effectively zero; and a black display occurs.

In the OCB type liquid crystal display device, even if a high voltage is applied to liquid crystal molecules arranged in a bend manner, all of the liquid crystal molecules are not arranged along the normal direction of a substrate, and retardation of a liquid crystal layer does not become completely zero. For example, on the liquid crystal panel LP shown in FIG. 10, in the case where an electric potential difference of 6 V has been applied between the pixel electrode PE and the opposite electrode CE, the degree of retardation of the liquid crystal layer 3 has been 60 nm.

Therefore, the optical compensation element 40 is equipped with a phase difference plate having retardation such that retardation of the liquid crystal layer 3 influenced at the time of observing a screen from a frontal position is cancelled in a state in which a specific voltage is applied, for example, in a state in which a high voltage is applied, thereby displaying black. Namely, the optical axis of such a phase difference plate becomes parallel to a direction in which retardation occurs in the liquid crystal layer 3, i.e., a direction D orthogonal to a liquid crystal alignment direction (an optical axis direction when liquid crystal molecules are positively projected) A, and has retardation in the direction D. This corresponds to the phase difference plates 43A and 43B having retardation in the frontal direction.

The frontal direction used here is specified in an intra-planar X and Y directions. However, when considering a refractive index of each optical member, all of the main refractive indexes nx, ny, and nz obtained by frontally projecting each optical member in a plane must be considered instead of considering only the intra-planer main refractive indexes nx and ny.

In this manner, the retardation in the frontal direction that the liquid crystal layer 3 has is cancelled; the liquid crystal layer 3 and the phase difference plates 43A and 43B are combined with each other, making it possible to form a state in which the degree of retardation becomes effectively zero, and display black at the time of observation in the frontal direction. That is, a display state, in which the retardation that the liquid crystal layer 3 has is adjusted by means of an applied voltage to match retardation that the phase difference plates 43A and 43B have, corresponds to a black display state.

As described above, in the OCB type liquid display device, the black display when observed from its frontal direction can be achieved by means of the mechanism as described previously using the phase difference plates 43A and 43B having retardation in the frontal direction. However, adjustment of the phase difference plates included in the optical compensation element 40 is not limited thereto. Although one of the characteristics of the OCB type liquid crystal display device is a wide viewing angle, it is desirable to adjust retardation between the liquid crystal layer and the phase difference plate and take a balance therebetween in order to make the most of this characteristic.

In the liquid crystal display device featured by a wide viewing angle, the wide viewing angle characteristic of a black display is particularly important. This is because the degree of clearness and sharpness of a black video image greatly influences sharpness of the video image, contrast feeling or the like. Here, let us consider optical compensation capable of achieving wide viewing angle when displaying black, i.e., capable of displaying black when viewed at any angle.

At the time of displaying black of the OCB type liquid crystal display device, a comparatively high voltage is applied to the liquid crystal layer 3, and thus, a majority of the liquid crystal molecules 31 are arranged in an electric field direction, i.e., rise in the normal direction of the substrate. The liquid crystal molecules 31, as shown in FIG. 13, are molecules having positive uniaxial optical characteristics that the main refractive index nz in the long axis direction of the molecules is greater than the main refractive indexes nx and ny in another direction. Here, with respect to the liquid crystal molecules 31, for the sake of convenience, the long axis direction (thickness direction) is defined as a Z direction, and intra-planer directions orthogonal thereto is defined as X and Y directions, respectively.

In a state in which the liquid crystal molecules 31 have risen in the normal direction of the substrate, no retardation occurs because, in the case where the screen is observed in the frontal direction, a distribution of the main refractive indexes are isotropic, i.e., the intra-planer main refractive indexes are equal to each other (nx=ny). However, in the case where the screen is observed in an oblique direction, the main refractive index nz in the long axis direction increases (nx, ny<nz) due to the influence of a side face of the liquid crystal molecules 31, and then, retardation according to the oblique direction occurs. Thus, part of the light having passed through the liquid crystal layer 3 may pass through the cross Nicol polarizing plates 41A and 41B.

Therefore, the optical compensation element 40 is equipped with a phase difference plate having an optical characteristic whose polarity is reversed from that of the liquid crystal molecules 31, for example, having negative uniaxial property. Namely, in such a phase difference plate, the main refractive index nz of its thickness direction is relatively small, and the intra-planer main refractive indexes nx and ny are relatively large (nx, ny>nz). This corresponds to the phase difference plates 42A and 42B having retardation in the thickness direction. The thickness direction used here is specified in the intra-planer X and Y directions and in the Z direction orthogonal thereto. When considering a refractive index of each optical member, all of the main refractive indexes nx, ny, and nz are considered in a three-dimensional manner.

By using a combination of such phase difference plates 42A and 42B, it is possible to eliminate retardation in the liquid crystal layer 3 in a case in which a screen of a black display state is observed in an oblique direction.

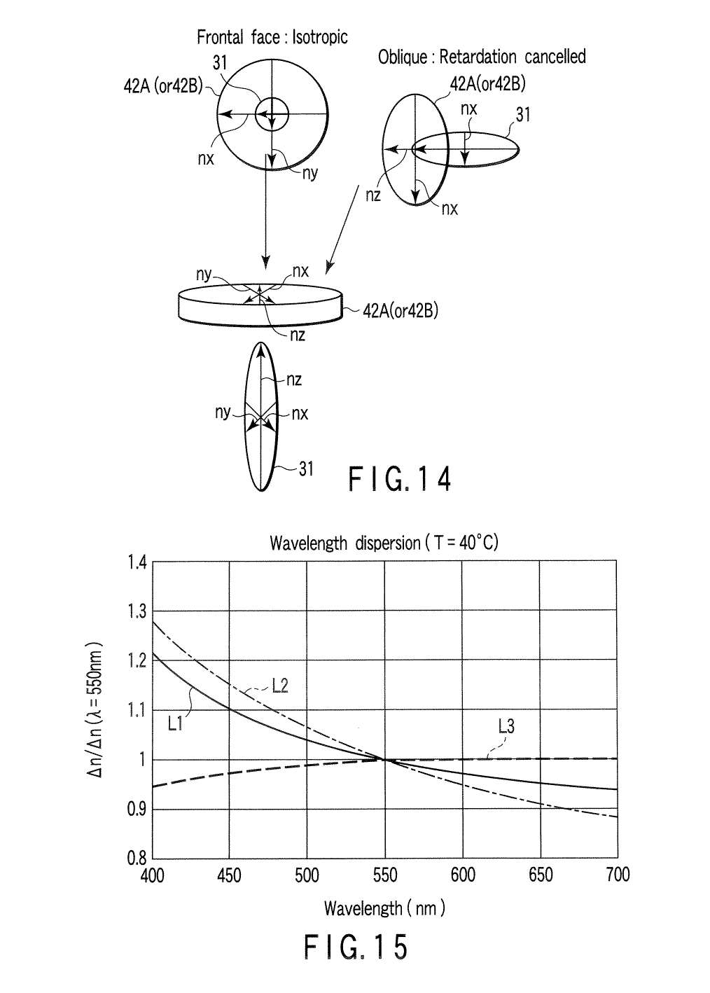

That is, as shown in FIG. 14, in the case where the screen is observed in a frontal direction, the liquid crystal molecules 31 and the phase difference plate 42A (or 42B) are isotropic in distribution of the main refractive indexes. That is, no retardation occurs because the intra-planar main refractive indexes are equal to each other (nx=ny). On the other hand, in the case where the screen is observed in an oblique direction, generated retardation of the liquid crystal molecules 31 and generated retardation of this phase difference plate 42A (or 42B) are orthogonal to each other. Namely, a distribution of main refractive indexes in the liquid crystal molecules 31 becomes nx, ny<nz, and then, there occurs retardation in which the influence of the main refractive index nz in the thickness direction is dominant in the liquid crystal layer. On the other hand, the main refractive index distribution in the phase difference plate 42A (or 42B) becomes nx, ny>nz, and, in the phase difference plate, there occurs retardation in which the influence of the main refractive index nx or ny in the intra-plane direction orthogonal to the thickness direction is dominant.

Absolute values of the degree of retardation in these liquid crystal layer and phase difference plate are made almost equal to each other, thereby making it possible to eliminate retardations from each other. In this manner, it becomes possible to cancel retardation in the thickness direction that the liquid crystal layer 3 has; to combine the liquid crystal layer 3 and the phase difference plates 42A and 42B with each other to form a state in which the degree of retardation becomes effectively zero; and to display black even when the screen is observed in an oblique direction. Here, for the sake of convenience, the degree of retardation is defined as Rth=Δn×d and as Δn=((nx+ny)/2−nz). In the formula, “d” denotes the thickness of a liquid crystal layer or a phase difference plate.

As described above, a basic concept of the achievement of a wide viewing angle in the OCB liquid crystal display device is that, in the case where a black display has been made by applying a comparatively high voltage to a liquid crystal layer, retardation of the liquid crystal layer that occurs in the frontal direction is cancelled by “a phase difference plate having retardation in the frontal direction”; and retardation of the liquid crystal layer that occurs in the oblique direction is eliminated by “the phase difference plate having retardation in the thickness direction”.

Here, the phase difference plates 43 and 43B having retardation in the frontal direction may be provided as a film obtained by hybrid arrangement of optical anisotropies having optically negative uniaxial property, for example, discotic liquid crystal molecules in the thickness direction of the phase difference plate. In addition, the phase difference plates 42A and 42B having retardation in the thickness direction may be biaxial films. In other words, a film obtained by hybrid arrangement of discotic liquid crystal molecules and the biaxial film can be construed as a film having retardation in the frontal direction and in the thickness direction.

In addition, a triacetyl cellulose (TAC) film may be used as the phase difference plates 42A and 42B having retardation in the thickness direction. In this case, the phase difference plates 42A and 42B may be compatibly used as base films of the polarizing plates 41A and 41B, respectively. This compatible use is effective for making an optical compensation element thinner and reducing cost.

Up to now, a single wavelength has been considered. In general, because importance is placed on luminance, retardation has been adjusted so that the characteristic at a green color wavelength in the vicinity of 550 nm becomes the best. However, with respect to the liquid crystal layer and the phase difference plate, their respective main refractive indexes nx, ny, and nz each have wavelength dependency.

FIG. 15 shows an example of a wavelength dispersion characteristic of the degree of retardation Δn·d of each one of a liquid crystal layer, a phase difference plate having retardation in the frontal direction, and a phase difference plates having retardation in the thickness direction. In the figure, the horizontal axis is defined as wavelength (nm), and the vertical axis is defined as a value Δn/Δn_{λ} obtained by standardizing the degree of retardation Δn·d relevant to the light of each wavelength by the degree of retardation Δn_{λ}·d relevant to light of a predetermined wavelength, i.e., light of λ=550 nm; and there is shown a wavelength dispersion characteristic of the value Δn/Δn_{λ}. The solid line L1 in the figure corresponds to the liquid crystal layer; the single dotted chain line L2 corresponds to a phase difference plate having retardation in the frontal direction; and the dashed line L3 corresponds to a phase difference plate having retardation in the thickness direction.

As described above, even if proper optical compensation has been carried out at a wavelength of 550 nm, when a wavelength is different from another one, proper adjustment may not be made. In particular, on the phase difference plate having retardation in the thickness direction, there is a great difference from the wavelength dispersion characteristic of the liquid crystal layer at the shorter wavelength side than 550 nm, and thus, retardation of the liquid crystal layer at the time of observing the screen in the oblique direction cannot be sufficiently cancelled. Here, a TAC film has been used as a phase difference plate having retardation in the thickness direction.

Therefore, an optical compensation element is equipped with at least two phase difference plates having retardation in the thickness direction, i.e., a first phase difference plate and a second phase difference plate, in order to compensate for a difference in wavelength dispersion characteristics between such a liquid crystal layer and phase difference plates having retardation in the thickness direction and to eliminate bluing more remarkably. Now, a description will be given with respect to an embodiment of an OCB type liquid crystal display device equipped with such an optical compensation element.

### Fourth Embodiment

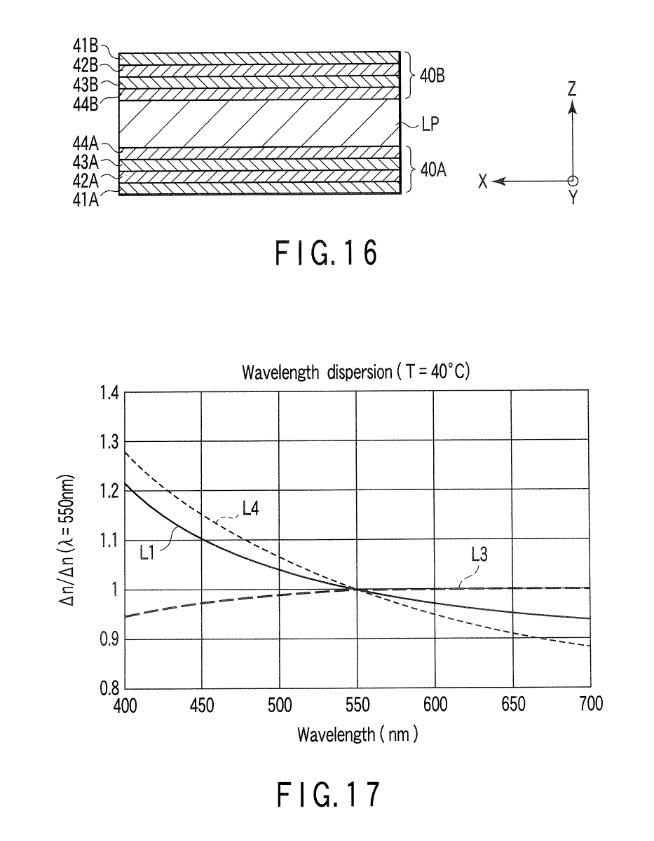

As shown in FIG. 16, an OCB type liquid crystal display device according to a fourth embodiment is equipped with optical compensation elements 40A and 40B on an outer face of an array substrate 1 and an outer face of an opposite substrate 2 of a liquid crystal panel LP, respectively.

The optical compensation element 40A at the side of the array substrate 1 has: a polarizing plate 41A; a first phase difference plate 42A having retardation in the thickness direction; a phase difference plate 43A having retardation in the frontal direction; and a second phase difference plate 44A having retardation in the thickness direction. Similarly, the optical compensation element 40B at the side of the opposite substrate 2 has: a polarizing plate 41B; a first phase difference plate 42B having retardation in the thickness direction; a phase difference plate 43B having retardation in the frontal direction; and a second phase difference plate 44B having retardation in the thickness direction. The transmission axis direction of a polarizing plate with respect to a liquid crystal alignment direction and the optical axis direction of a variety of phase difference plates are similar to examples shown in FIGS. 11 and 12.

The first phase difference plates 42A and 42B are TAC films in the same manner as in the example described previously, for example. Such first phase difference plates 42A and 42B each have the wavelength dispersion characteristics as shown in FIG. 15. That is, with respect to the light of a shorter wavelength than a predetermined wavelength (550 nm), a value Δn/Δn_{λ} standardized in the first phase difference plates 42A and 42B is smaller than a value Δn/Δn_{λ} standardized in the liquid crystal layer 3.

In this case, the second phase difference plates 44A and 44B are selected as having wavelength dispersion characteristics such that a difference in wavelength dispersion characteristics of the liquid crystal layer 3 and the first phase difference plates 42A and 42B is compensated for. That is, with respect to the light of a shorter wavelength than a predetermined wavelength (550 nm), a value Δn/Δn_{λ} standardized in the second phase difference plates 44A and 44B is required to be greater than a value Δn/Δn_{λ} standardized in the liquid crystal layer 3. Namely, such a second phase difference plate has an advantageous effect of eliminating the wavelength dispersion characteristics of the first phase difference plate.

As such second phase difference plates 44A and 44B, an optical anisotropy having a negative uniaxial property, for example, a phase difference plate or the like having discotic liquid crystal molecules arranged in the thickness direction (normal line direction), can be applied so that the main refractive index in the thickness direction nz is relatively small and the intra-planer main refractive indexes nx and ny become relatively large (nx, ny>nz).

FIG. 17 shows an example of wavelength dispersion characteristics of the degree of retardation Δn·d of each one of the liquid layer, the first phase difference plate, and the second phase difference plate. Here, as in FIG. 15, the degree of retardation Δn·d relevant to the light of each wavelength is standardized by light of a predetermined wavelength, i.e., by the degree of retardation Δn_{λ}·d relevant to the light of λ=550 nm, and shows wavelength dispersion characteristics of a value Δn/Δn_{λ}. The solid line L1 in the figure corresponds to the liquid crystal layer, the dashed line L3 corresponds to the first phase difference plate, and the dashed line L4 corresponds to the second phase difference plate.

As shown in FIG. 17, at the shorter wavelength side than a predetermined wavelength, the wavelength dispersion characteristics of the first phase difference plate are smaller than the wavelength dispersion characteristics of the liquid crystal layer, and the wavelength dispersion characteristics of the second phase difference plate are larger than the wavelength dispersion characteristics of the liquid crystal layer. In other words, with respect to a difference between a maximum value and a minimum value of a value Δn/Δn_{λ} in a visible light wavelength range from a wavelength of 400 to 700 nm (or in a wavelength range of a shorter wavelength side than a predetermined wavelength of 550 nm), the first phase difference plate is smaller than the liquid crystal layer and the second phase difference plate is greater than the liquid crystal layer. In further other words, with respect to a gradation of the wavelength dispersion characteristic curve in the visible light wavelength range from a wavelength of 400 to 700 nm (or in the wavelength range of a shorter wavelength side than a predetermined wavelength of 500 nm), the first phase difference plate is smaller than the liquid crystal layer and the second phase difference plate is greater than the liquid crystal layer.

Namely, the comprehensive wavelength dispersion characteristics of the first phase difference plate and the second phase difference plate are substantially equivalent to the wavelength dispersion characteristics of the liquid crystal layer by combining the first phase difference plate having wavelength dispersion characteristics that are small with respect to the wavelength dispersion characteristics of the value Δn/Δn_{λ} in the liquid crystal layer with the second phase difference plate having wavelength dispersion characteristics that are great with respect to the wavelength dispersion characteristics of the value Δn/Δn_{λ} in the liquid crystal layer. In this manner, retardation that occurs in the liquid crystal layer when the screen is observed in an oblique direction can be canceled and the wavelength dispersion characteristics of retardation in the liquid crystal layer can be compensated for to some extent.

Thus, the above configurations are combined with the color filter according to the first or second embodiment, whereby, even when the screen is observed in an oblique direction as well as in a frontal direction, the transmittance of the liquid crystal panel LP can be reduced more sufficiently at the time of a black display, making it possible to enhance a contrast and enabling a black display with less coloring. Therefore, there can be provided a liquid crystal display device having its excellent viewing angle characteristics and display resolution.

The optical compensation element 40 as described above can be manufactured by adding the second phase difference plate, having a function of adjusting the whole wavelength dispersion characteristics in the liquid crystal display device, to an optical element in which a polarizing plate, the first phase difference plate having retardation in the thickness direction, and a phase difference plate having retardation in the frontal direction are integrally configured. For example, the optical compensation element 40 is manufactured by coating to a surface of the optical element a material that functions as a second phase difference plate having retardation in the thickness direction or adhering a film that functions as a second phase difference plate. Namely, the optical compensation element is equipped with the second phase difference plate in location that is the closest to the side of the liquid crystal panel LP.

The optical compensation element may be equipped with a first phase difference plate on a surface of an optical element in which a second phase difference plate is integrally configured together with a polarizing plate or the like. In this case, the first phase difference plate is equipped in location that is the closest to the side of the liquid crystal panel LP.

Manufacturing the optical compensation element in accordance with such a manufacturing method brings about simplification of the manufacturing process, reduction of manufacturing cost, and further, cost reduction of the optical compensation element, and is very effective in terms of the manufacturing process.

In addition, it is desirable that the second phase difference plate (or first phase difference plate) have a thickness that produces a degree of retardation substantially equal to the difference between the degree of retardation in the first phase difference plate (or second phase difference plate) and the degree of retardation in the liquid crystal layer with respect to light of the same wavelength. That is, the degree of retardation depends on thickness “d” of each optical member, as described above. Therefore, it is desirable to optimize the degree of retardation of a liquid crystal layer so as to be cancelled in combination of the thicknesses of the respective plates with respect to a plurality of phase difference plates having retardation in the thickness direction, the plates configuring the optical compensation element.

Namely, as in an example shown in FIG. 17, it is required that the first phase difference plate having wavelength dispersion characteristics that are comparatively small in difference is set to be comparatively thin, and the second phase difference plate having wavelength dispersion characteristics that are comparatively great in difference is set to be comparatively thick, with respect to the wavelength dispersion characteristics of a value Δn/Δn_{λ} in the liquid crystal layer. Here, the second phase difference plate is desirably at least twice as thick as the first phase difference plate. In the fourth embodiment, the thicknesses of the first phase difference plates 42A and 42B were each set to 100 μm, whereas the thicknesses of the second phase difference plates 44A and 44B were each set to 200 μm that are optimally equivalent to twice that of the first phase difference plate.

### Fifth Embodiment

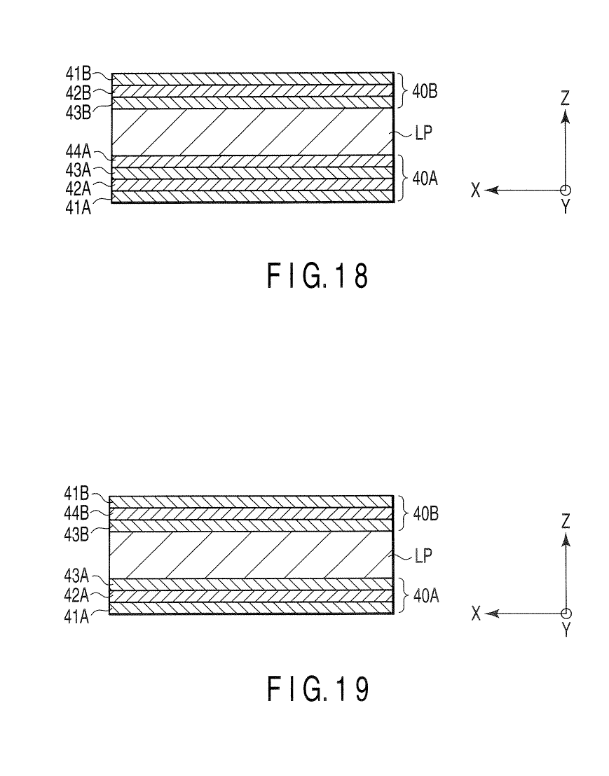

As shown in FIG. 18, as in the fourth embodiment, an OCB type liquid crystal display device according to a fifth embodiment is equipped with optical compensation elements 40A and 40B, respectively, on an outer face of an array substrate 1 and on an outer face of an opposite substrate 2 of a liquid crystal panel LP. Like constituent elements of the fourth embodiment are designated by like reference numerals. A detailed description thereof is omitted here.

The optical compensation element 40A at the side of the array substrate 1 has: a polarizing plate 41A; a first phase difference plate 42A; a phase difference plate 43A having retardation in a frontal direction; and a second phase difference plate 44A. On the other hand, the optical compensation element 40B at the side of the opposite substrate 2 has: a polarizing plate 41B; a first phase difference plate 42B; and a phase difference plate 43B having retardation in a frontal direction, and is not equipped with an element equivalent to the second phase difference plate.

As has been already described previously, it is desirable that the second phase difference plate (or first phase difference plate) have a thickness such that the degree of retardation is substantially equal to the difference between the degree of retardation in a first phase difference plate (or second phase difference plate) and the degree of retardation in a liquid crystal layer with respect to light of the same wavelength.

That is, with respect to a plurality of phase difference plates having retardation in the thickness direction configuring an optical compensation element, it is sufficient if the degree of retardation of a liquid crystal layer is optimized so as to be canceled depending on a combination of the thicknesses of the respective plates. Namely, the comprehensive wavelength dispersion characteristics depending on the two first phase difference plates 42A and 42B provided at the liquid crystal display device are eliminated by the wavelength dispersion characteristics depending on one second phase difference plate 44A. It is sufficient that the resulting wavelength dispersion characteristics substantially coincide with the wavelength dispersion characteristics depending on the liquid crystal layer 3.

In the fifth embodiment, in the case of applying a first phase difference plate and a second phase difference plate having wavelength dispersion characteristics as shown in FIG. 17, the thicknesses of the first phase difference plates 42A and 42B each were set to 100 μm, whereas the thickness of the second phase difference plate 44A was optimally set to 400 μm equivalent to four times that of the first phase difference plate.

According to the fifth embodiment as described above, an advantageous effect similar to that of the fourth embodiment can be attained, of course. In addition to this advantageous effect, it is sufficient if a second phase difference plate is provided only in one optical compensation element, and the number of optical members can be reduced, enabling cost reduction.

### Sixth Embodiment

As shown in FIG. 19, as in the fourth embodiment, an OCB type liquid crystal display device according to a sixth embodiment is equipped with optical compensation elements 40A and 40B, respectively, on an outer face of an array substrate 1 and on an outer face of an opposite substrate 2 of a liquid crystal panel LP. Like constituent elements of the fourth embodiment are designated by like reference numerals. A detailed description thereof is omitted here.

The optical compensation element 40A at the side of the array substrate 1 has; a polarizing plate 41A; a first phase difference plate 42A; and a phase difference plate 43A having retardation in a frontal direction. On the other hand, the optical compensation element 40B at the side of the opposite substrate 2 has: a polarizing plate 41B; a second phase difference plate 44B; and a phase difference plate 43B having retardation in a frontal direction.

In the sixth embodiment, in the case of applying a first phase difference plate and a second phase difference plate having wavelength dispersion characteristics as shown in FIG. 17, the thickness of the first phase difference plate 42A was set to 200 μm, whereas the thickness of the second phase difference substrate 44B was optimally set to 400 μm equivalent to twice that of the first phase difference plate.

According to the sixth embodiment as described above, an advantageous effect similar to that of the fourth embodiment can be attained, of course. In addition to this advantageous effect, it is sufficient if a first phase difference plate and a second phase difference pate are provided in one optical compensation element, and the number of optical members can be further reduced, enabling cost reduction.

As has been described in these fourth to sixth embodiments, it is sufficient if the respective optical members that function as a first phase difference plate and a second phase difference plate are provided in the optical compensation element on one by one element basis in configuring a liquid crystal display device. Namely, it is sufficient if the optical member that functions as a first phase difference plate is included in at least one of the optical compensation element 40A at the side of the array substrate 1 and the optical compensation element 40B at the side of the opposite substrate. Similarly, it is sufficient if the optical member that functions as a second phase difference plate is included in at least one of the optical compensation element 40A at the side of the array substrate 1 and the optical compensation element 40B at the side of the opposite substrate. Then, by optimizing a combination of thicknesses of these optical members, a good display resolution can be achieved at a wide viewing angle, as has been already described previously.

### Seventh Embodiment

In the embodiments described above, while more advantageous effect has been attained by combining a plurality of phase difference plates having retardation in a thickness direction with a configuration of the color filter described above, a multi-gap structure that is different between colors having different thicknesses of a liquid crystal layer of respective color pixels may be combined with a configuration of the color filter described above or the multi-gap structure may be further combined with the above described embodiments.

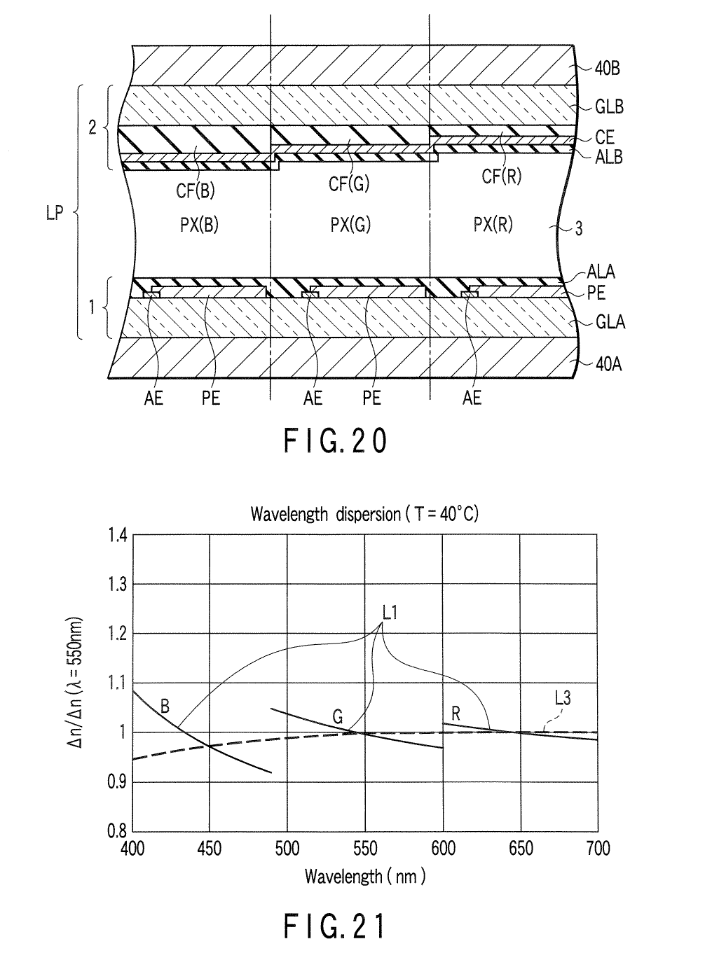

For example, a liquid crystal panel LP as shown in FIG. 20 is provided as an example of forming a multi-gap structure. That is, the liquid crystal panel LP has a red pixel PX (R), a green pixel PX (G), and a blue pixel PX (B), as color pixels of a plurality of colors. The green pixel PX (G) is equipped with a green color filter CF (G) having a predetermined thickness on an opposite substrate 2. In contrast, the red pixel PX (R) is equipped with a red color filter CF (R) that is thinner than the green color filter CF (G) on the opposite substrate 2. In addition, the blue pixel PX (B) is equipped with a blue color filter CF (B) that is thicker than the green color filter CF (G) on the opposite substrate 2.

In this manner, when the array substrate 1 and the opposite substrate 2 are adhered parallel to each other, a predetermined gap is formed in the green pixel PX (G), whereas a greater gap than that of the green pixel PX (G) is formed in the red pixel PX (R) and a smaller gap than that of the green pixel PX (G) is formed in the blue pixel PX (B). Namely, a multi-gap structure is formed such that the liquid crystal layer 3 that the red pixel PX (R) has is thicker than the liquid crystal layer 3 that the green pixel PX (G) has; and the liquid crystal layer 3 that the green pixel PX (G) has is thinner than the liquid crystal layer 3 that the green pixel PX (G) has.

In this way, by adjusting the thickness of the liquid crystal layer 3 in each color pixel, the effective degree of retardation Rth depending on the liquid crystal layer 3 can be adjusted, and then, coloring can be reduced more remarkably.

For example, in the case of combining an optical compensation elements 40A and 40B and a liquid crystal panel LP having a multi-gap structure, as shown in FIG. 11, the wavelength dispersion characteristics of the degree of retardation Δn·d depending on the liquid crystal layer 3 in each color pixel and each one of the phase difference plates 42A and 42B having retardation in the thickness direction are obtained as shown in FIG. 21, for example. Here, in the same way as in FIG. 15, the degree of retardation Δn·d relevant to the light of each wavelength is standardized by the degree of retardation Δn_{λ}·d relevant to the light of a predetermined wavelength, i.e., λ=550 nm, and shows wavelength dispersion characteristics of a value Δn/Δn_{λ}. The solid line L1 in the figure corresponds to a liquid crystal layer, and the dashed line L3 corresponds to a phase difference plate having retardation in the thickness direction.

On the liquid crystal panel LP applied here, the liquid crystal layer 3 of the blue pixel PX (B) was formed to be thinner by 0.3 μm with respect to the liquid crystal layer 3 of the green pixel PX (G), and the liquid crystal layer 3 of the red pixel PX (R) was formed to thicker by 0.05 μm.

As shown in FIG. 21, a multi-gap structure has been employed, whereby the wavelength dispersion characteristics depending on the liquid crystal layer of each color pixel is sufficiently compensated for in the vicinity of the center wavelength (450, 550, 650 nm) of each one of the colors.

Therefore, each of the optical compensation elements in the fourth to sixth embodiments already described previously is combined with a liquid crystal pane LP having a multi-gap structure described here, whereby a good display resolution can be achieved at a further wide viewing angle. Namely, while complete optical compensation cannot be achieved even with the configurations according to the fourth to sixth embodiments described above, it is effective to employ a multi-gap structure for fine adjustment of characteristics.

That is, an optimal material for the first phase difference plate and the second phase difference plate cannot be selected flexibly, thus making it difficult to achieve fine adjustment using these phase difference plates. In the case of combining the optical compensation element and a liquid crystal panel LP having a multi-gap structure, as described in the fourth embodiment, it has been proper that the liquid crystal layer 3 of the blue pixel PX (B) is formed to be thinner by 0.1 μm with respect to the liquid crystal layer 3 of the green pixel PX (G) and that the liquid crystal layer 3 of the red pixel PX (R) is as thick as the green pixel PX (G). Under this condition, good display resolution was obtained without aggravating color purity.

The first phase difference plate and the second phase difference plate having retardation in the thickness direction may be negative uniaxial films such as polycarbonate (PC) films; may be films obtained by arranging optical anisotropies (for example, discotic liquid crystal molecules) having negative uniaxial property in the thickness direction; and further, may be biaxial films compatible with films having a phase difference in the transmission axis direction of the polarizing plates.

### Eighth Embodiment

A liquid crystal display device according to an eighth embodiment is equipped with a function of compensating an application voltage in response to display characteristics of an OCB liquid crystal display element shown in each of the first to seventh embodiments. Therefore, like constituent elements of the first to seventh embodiments are designated with like reference numerals. A detailed description thereof is omitted here.

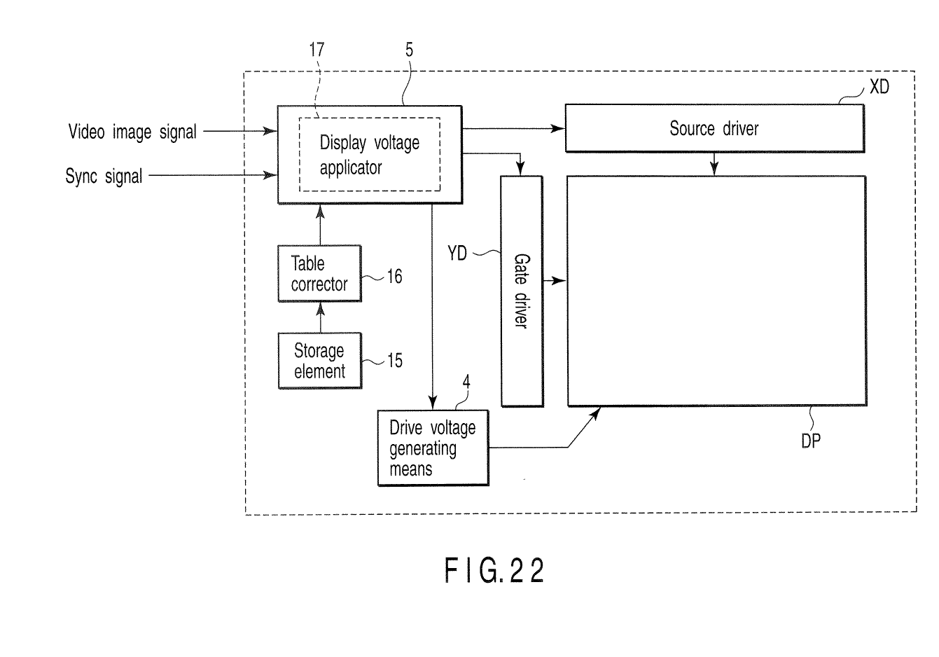

FIG. 22 is a block diagram depicting a configuration of a liquid crystal display device according to the present embodiment.

The liquid crystal display device is equipped with a controller circuit 5 in addition to each of the functions described above. A display voltage applicator 17 is provided in the controller circuit 5. The display voltage applicator 17 converts a video image signal to an application voltage for displaying a video image, based on a predetermined signal voltage conversion table, and then, applies the converted voltage to a liquid crystal pixel PX.

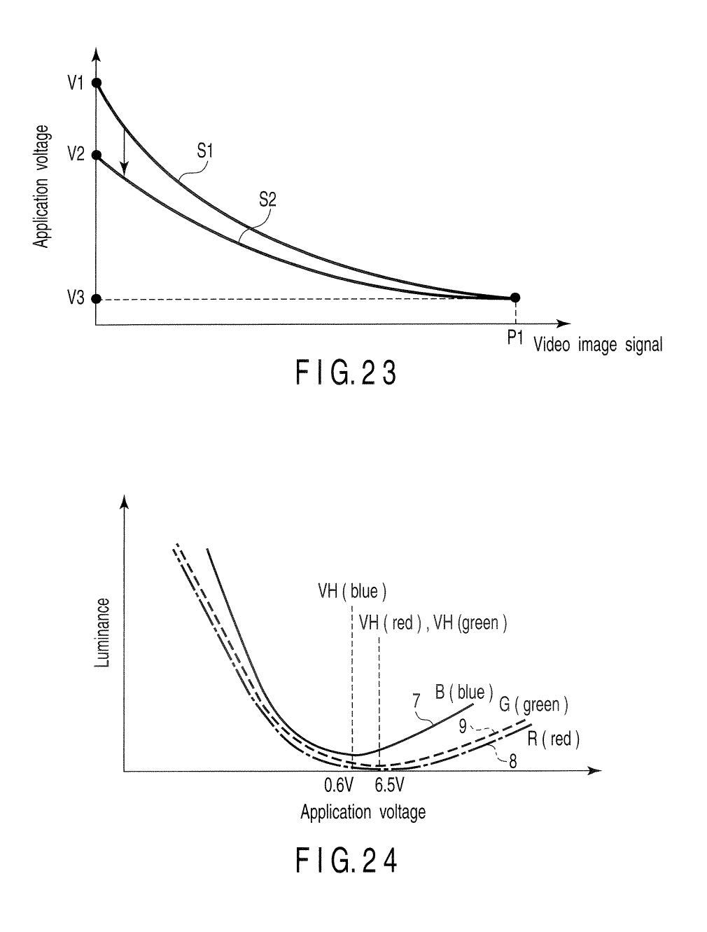

FIG. 23 is a graph for illustrating a signal voltage conversion table. The horizontal axis indicates an amplitude of a video image signal to be inputted to the display voltage applicator 17 and the vertical axis indicates an application voltage to be applied to an OCB liquid crystal display element. The signal voltage conversion tables are provided for each of blue, red, and green colors. In FIG. 23, a description will be given by way of example of a red signal voltage conversion table.

A relationship between an amplitude of a video image signal and an application voltage represented by a curve S1 is recorded in the signal voltage conversion table. In the curve S1, the application voltage is set at a voltage V1 when the amplitude of the video image signal is zero. In the curve S1, a value of the application value decreases as the amplitude of the video image signal increases. In a predetermined amplitude value P1 of a video image signal, the current value decreases to a value V3 lower than the value V1 of the application voltage.

A storage element 15 is provided in the liquid crystal display device. The storage element 15 is composed of EP-ROM, and luminance voltage characteristic data showing a relationship between the luminance of a video image displayed by the liquid crystal pixel PX and the application voltage to be applied to the liquid crystal pixel PX is stored.

FIG. 24 is a graph depicting the luminance voltage characteristic data stored in the storage element 15. The horizontal axis represents the application voltage to be applied to the liquid crystal pixel PX and the vertical axis represents the luminance of a video image displayed by the liquid crystal pixel PX. This luminance voltage characteristic data includes a blue gamma characteristic 7, a red gamma characteristic 8, and a green gamma characteristic 9.

A value of an application voltage when the luminance of the video image displayed by the liquid crystal pixel PX becomes minimum is different among the blue gamma characteristic 7, the red gamma characteristic 8, and the green gamma characteristic 9. In an example shown in FIG. 24, in the blue gamma characteristic 7, the value VH (blue) of the application voltage generated when the luminance is minimum is obtained as approximately 6.0 V. In the red gamma characteristic 8 and the green gamma characteristic 9, the values VH (red) and VH (green) of the application voltage generated when the luminance is minimum are obtained as approximately 6.5 V, respectively. The black level display voltage values for achieving a display of a black level of pixels of red (G), green (G), and blue (B) are set at values VH (red), VH (green), and VH (blue) of the application voltages generated when the luminance is minimum. Therefore, the pixels of red (R) and green (G) displays a black level when an application voltage of about 6.5 V is applied, and the pixel of blue (B) displays a black level when an application voltage of about 6.0 V is applied.

The liquid crystal display device is equipped with a table corrector 16. The table corrector 16 corrects the signal voltage conversion table provided in the display voltage applicator 17 based on the luminance voltage characteristic data stored in the storage element 15.

In the thus configured liquid crystal display device, first, when a power source, although not shown, which is provided in the liquid crystal display device, is turned ON, the table corrector 16 reads out from the storage element 15 the luminance voltage characteristic data stored in the storage element 15, and then, corrects the signal voltage conversion table provided in the display voltage applicator 17 based on the read out luminance voltage characteristic data.

For example, the table corrector 16, as shown in FIG. 23, corrects the signal voltage conversion table so as to change a curve S1 to a curve S2. In the curve S2, when the amplitude of a video image signal is zero, an application voltage is set at a value V2 that is lower than a value V1. In the curve S2, as in the curve S1, a value of the application voltage decreases as the amplitude of the video image signal increases. In a predetermined amplitude value P1 of a video image signal, the current value decreases to a value V3 that is lower than the values V1 and V2 of the application voltage.

In this manner, the table corrector 16 corrects the signal voltage conversion table so as to offset the curve S1 by compressing the value of the application voltage.

Then, the display voltage applicator 17 receives a video image signal and a sync signal. Next, the display voltage applicator 17 converts a video image signal to an application voltage based on the signal voltage conversion table corrected by means of the table corrector 16. Then, the display voltage applicator 17 applies the converted application voltage to the liquid crystal pixel PX via a source driver XD, a gate driver YD, and a drive voltage generating circuit 4.

As has been described above, according to the present embodiment, the luminance voltage characteristic data indicating a relationship between the luminance of a video image displayed by means of the liquid crystal pixel PX and the application voltage to be applied to the liquid crystal pixel PX is stored in the storage element 15. Then, the application voltage, converted from the video image signal in accordance with the signal voltage conversion table corrected based on the luminance voltage characteristic data stored in the storage element 15, is applied to the liquid crystal pixel PX. Thus, the signal voltage conversion table for converting a video image signal to an application voltage can be corrected in accordance with the display characteristics of the OCB liquid crystal display element allocated on an LCD panel of the liquid crystal display device. As a result, an optimal contrast value can be obtained on a color by color basis, for example.

The storage element 15 in the liquid crystal display device according to the present embodiment may provide luminance voltage characteristic data in a rewritable manner in response to a change of an ambient temperature of the liquid crystal display device. If the storage element 15 is thus configured, when the ambient temperature of the liquid crystal display device has changed, it is possible to rewrite at least one of the blue gamma characteristic 7, the red gamma characteristic 8, and the green gamma characteristic 9 included in the luminance voltage characteristic data. Thus, in a video image displayed by the liquid crystal pixel PX of the liquid crystal display device, for example, it is possible to prevent lowering of a contrast at a high temperature.

Although there has been shown an example in which the luminance voltage characteristic data stored in the storage element 15 includes the blue gamma characteristic 7, the red gamma characteristic 8, and the green gamma characteristic 9, the present invention is not limited thereto. Among the gamma characteristics, only the black level display voltage value of the pixels of red (R), green (G), and blue (B) may be stored as luminance voltage characteristic data in the storage element 15.

Although the present embodiment has described a technique of correcting a gamma table, the present invention is not limited thereto. The gist of the present invention is featured in that data required to obtain an optimal contrast is provided in a liquid crystal module in response to their respective liquid crystal modules. A gamma table may be provided in the liquid crystal module. In addition, data on green that is the most influential to luminance data may be represented.

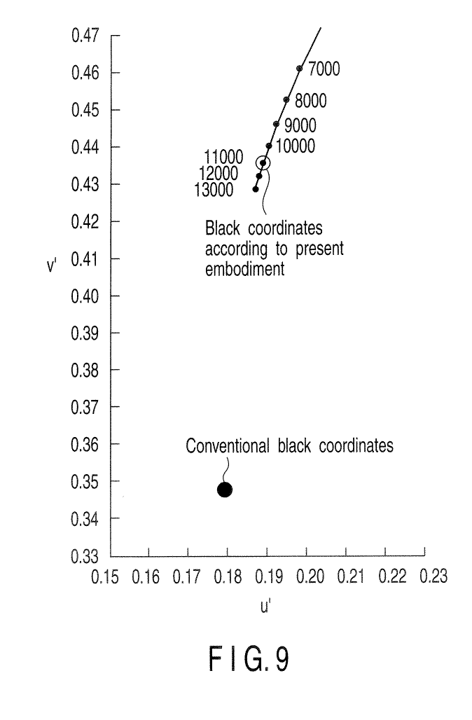

FIG. 9 is a view illustrating an advantageous effect that can be attained in each of the embodiments. FIG. 9 represents a part of a color coordinate system in which u′ and v′ are defined as parameters. In the conventional OCB liquid crystal element using a color filter, the black display coordinate value has belonged to a blue region. Therefore, bluing has been made for a black display. On the other hand, this state is improved in the OCB liquid crystal element to which the invention according to the first and second embodiments is applied, and then, the black display coordinate value is converted to a color temperature that is a region free of coloring. Here, the converted value belongs to a position of 11,000 K. In addition, because v′ is equal to or greater than 0.4, improvement has been made to an extent such that bluing does not become a problem. Further, because v′ is equal to or greater than 0.43, a display with a high resolution is obtained.

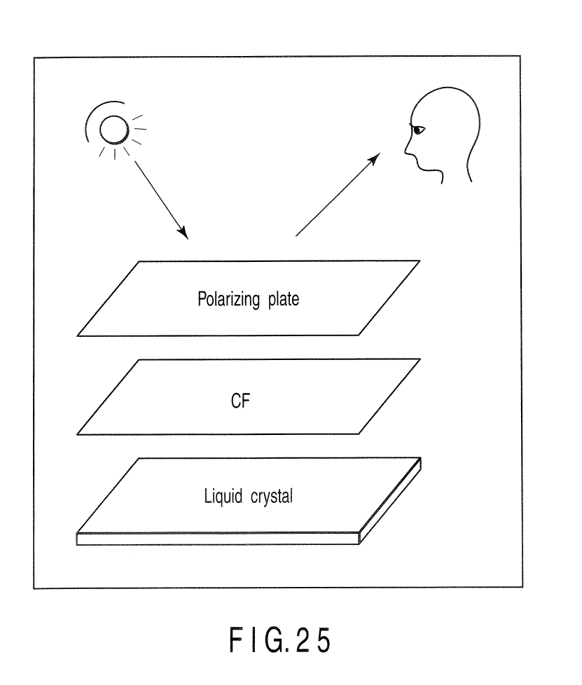

Each of the forgoing embodiments has described a transmission type liquid crystal display device by way of example. However, the present invention can be applied to a reflection type liquid crystal display device without being limited to the embodiments. That is, as shown in FIG. 25, the present invention can be applied to a liquid crystal display device configured so that a polarizing plate has been allocated on one side (viewing side).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device, comprising:
a plurality of liquid crystal pixels equipped with an OCB liquid crystal layer between a pair of substrates;
color filters including red, green, and blue color layers allocated so as to overlap on the plurality of liquid crystal pixels; and
a polarizing plate arranged at least at a viewing side in opposite to the liquid crystal pixels,
wherein the blue color layer has a contrast that is greater than that of the green color layer.

2. The liquid crystal display device according to claim 1, wherein the blue color layer has a contrast that is greater than that of the red color layer.

3. The liquid crystal display device according to claim 2, further comprising an optical compensation element arranged at least at a viewing side adjacent to the polarizing plate,
wherein the optical compensation element optically compensates for retardation of the OCB liquid crystal layer in a predetermined display state in which a voltage is applied to the OCB liquid crystal layer; and
a thickness of the OCB liquid crystal layer is different from another thickness between different color pixels.

4. The liquid crystal display device according to claim 2, comprising:
a voltage applying part configured to, based on conversation data that represents a relationship between a video image signal and a voltage applied to the OCB liquid crystal layer, generate a corresponding application voltage from the video image signal, and apply the generated voltage to the OCB liquid crystal layer;
a storage part configured to store characteristic data that represents a relationship between a voltage applied to the OCB liquid crystal layer and a luminance; and
a correction part configured to correct the conversion data based on the characteristic data,
wherein the conversion data and the characteristic data are provided for each of blue, red, and green colors.

5. The liquid crystal display device according to claim 1, wherein the green color layer has a contrast that is greater than that of the red color layer.

6. The liquid crystal display device according to claim 5, further comprising an optical compensation element arranged at least at a viewing side adjacent to the polarizing plate,
wherein the optical compensation element optically compensates for retardation of the OCB liquid crystal layer in a predetermined display state in which a voltage is applied to the OCB liquid crystal layer; and
a thickness of the OCB liquid crystal layer is different from another thickness between different color pixels.

7. The liquid crystal display device according to claim 5, comprising:
a voltage applying part configured to, based on conversation data that represents a relationship between a video image signal and a voltage applied to the OCB liquid crystal layer, generate a corresponding application voltage from the video image signal, and apply the generated voltage to the OCB liquid crystal layer;
a storage part configured to store characteristic data that represents a relationship between a voltage applied to the OCB liquid crystal layer and a luminance; and
a correction part configured to correct the conversion data based on the characteristic data,
wherein the conversion data and the characteristic data are provided for each of blue, red, and green colors.

8. The liquid crystal display device according to claim 1, wherein the contrast of the blue color layer is equal to or greater than 2000:1.

9. The liquid crystal display device according to claim 8, further comprising an optical compensation element arranged at least at a viewing side in opposite the polarizing plate,
wherein the optical compensation element optically compensates for retardation of the OCB liquid crystal layer in a predetermined display state in which a voltage is applied to the OCB liquid crystal layer; and
a thickness of the OCB liquid crystal layer is different from another thickness between different color pixels.

10. The liquid crystal display device according to claim 8, comprising:
a voltage applying part configured to, based on conversation data that represents a relationship between a video image signal and a voltage applied to the OCB liquid crystal layer, generate a corresponding application voltage from the video image signal, and apply the generated voltage to the OCB liquid crystal layer;
a storage part configured to store characteristic data that represents a relationship between a voltage applied to the OCB liquid crystal layer and a luminance; and
a correction part configured to correct the conversion data based on the characteristic data,
wherein the conversion data and the characteristic data are provided for each of blue, red, and green colors.

11. The liquid crystal display device according to claim 1, further comprising an optical compensation element arranged at least at a viewing side adjacent to the polarizing plate,
wherein the optical compensation element optically compensates for retardation of the OCB liquid crystal layer in a predetermined display state in which a voltage is applied to the OCB liquid crystal layer; and
a thickness of the OCB liquid crystal layer is different from another thickness between different color pixels.

12. The liquid crystal display device according to claim 1, comprising:
a voltage applying part configured to, based on conversation data that represents a relationship between a video image signal and a voltage applied to the OCB liquid crystal layer, generate a corresponding application voltage from the video image signal, and apply the generated voltage to the OCB liquid crystal layer;
a storage part configured to store characteristic data that represents a relationship between a voltage applied to the OCB liquid crystal layer and a luminance; and
a correction part configured to correct the conversion data based on the characteristic data,
wherein the conversion data and the characteristic data are provided for each of blue, red, and green colors.

13. A liquid crystal display device, comprising:
a plurality of liquid crystal pixels equipped with an OCB liquid crystal layer between a pair of substrates;
color filters including red, green, and blue color layers allocated so as to overlap on the plurality of liquid crystal pixels; and
a polarizing plate arranged at least at a viewing side in opposite to the liquid crystal pixels,
wherein at least one of the color filters includes a light transmission region that transmits light from the liquid crystal pixels at a transmittance that is higher than that of a periphery.

14. The liquid crystal display device according to claim 13, wherein the light transmission region is an aperture provided at the color filter.

15. The liquid crystal display device according to claim 14, wherein the aperture is equal to or smaller than 1/15 of an aperture area of the liquid crystal pixel.

16. The liquid crystal display device according to claim 15, further comprising an optical compensation element arranged at least at a viewing side in opposite to the polarizing plate,
wherein the optical compensation element optically compensates for retardation of the OCB liquid crystal layer in a predetermined display state in which a voltage is applied to the OCB liquid crystal layer; and
a thickness of the OCB liquid crystal layer is different from another thickness between different color pixels.

17. The liquid crystal display device according to claim 15, comprising:
a voltage applying part configured to, based on conversation data that represents a relationship between a video image signal and a voltage applied to the OCB liquid crystal layer, generate a corresponding application voltage from the video image signal, and apply the generated voltage to the OCB liquid crystal layer;
a storage part configured to store characteristic data that represents a relationship between a voltage applied to the OCB liquid crystal layer and a luminance; and
a correction part configured to correct the conversion data based on the characteristic data,
wherein the conversion data and the characteristic data are provided for each of blue, red, and green colors.

18. The liquid crystal display device according to claim 14, further comprising an optical compensation element arranged at least at a viewing side adjacent to the polarizing plate,
wherein the optical compensation element optically compensates for retardation of the OCB liquid crystal layer in a predetermined display state in which a voltage is applied to the OCB liquid crystal layer; and
a thickness of the OCB liquid crystal layer is different from another thickness between different color pixels.

19. The liquid crystal display device according to claim 14, comprising:
a voltage applying part configured to, based on conversation data that represents a relationship between a video image signal and a voltage applied to the OCB liquid crystal layer, generate a corresponding application voltage from the video image signal, and apply the generated voltage to the OCB liquid crystal layer;
a storage part configured to store characteristic data that represents a relationship between a voltage applied to the OCB liquid crystal layer and a luminance; and
a correction part configured to correct the conversion data based on the characteristic data,
wherein the conversion data and the characteristic data are provided for each of blue, red, and green colors.

20. The liquid crystal display device according to claim 13, wherein the light transmission region is a thin film portion that is thinner than a peripheral region in the color filter.

21. The liquid crystal display device according to claim 20, further comprising an optical compensation element arranged at least at a viewing side adjacent to the polarizing plate,
wherein the optical compensation element optically compensates for retardation of the OCB liquid crystal layer in a predetermined display state in which a voltage is applied to the OCB liquid crystal layer; and
a thickness of the OCB liquid crystal layer is different from another thickness between different color pixels.

22. The liquid crystal display device according to claim 20, comprising:
a voltage applying part configured to, based on conversation data that represents a relationship between a video image signal and a voltage applied to the OCB liquid crystal layer, generate a corresponding application voltage from the video image signal, and apply the generated voltage to the OCB liquid crystal layer;
a storage part configured to store characteristic data that represents a relationship between a voltage applied to the OCB liquid crystal layer and a luminance; and
a correction part configured to correct the conversion data based on the characteristic data,
wherein the conversion data and the characteristic data are provided for each of blue, red, and green colors.

23. The liquid crystal display device according to claim 13, further comprising an optical compensation element arranged at least at a viewing side in opposite to the polarizing plate,
wherein the optical compensation element optically compensates for retardation of the OCB liquid crystal layer in a predetermined display state in which a voltage is applied to the OCB liquid crystal layer; and
a thickness of the OCB liquid crystal layer is different from another thickness between different color pixels.

24. The liquid crystal display device according to claim 13, comprising:
a voltage applying part configured to, based on conversation data that represents a relationship between a video image signal and a voltage applied to the OCB liquid crystal layer, generate a corresponding application voltage from the video image signal, and apply the generated voltage to the OCB liquid crystal layer;
a storage part configured to store characteristic data that represents a relationship between a voltage applied to the OCB liquid crystal layer and a luminance; and
a correction part configured to correct the conversion data based on the characteristic data,
wherein the conversion data and the characteristic data are provided for each of blue, red, and green colors.
